(19) United States
(12) Patent Application Publication
(10) Pub. No.: US 2023/0258511 A1
(43) Pub. Date: Aug. 17, 2023

(54) LOAD SENSOR

(71) Applicant: Panasonic Intellectual Property Management Co., Ltd., Osaka (JP)

(72) Inventors: Yuta MORIURA, Osaka (JP); Susumu URAGAMI, Osaka (JP); Takashi MATSUMOTO, Osaka (JP); Yodai MATSUMURA, Osaka (JP); Hiroyuki FURUYA, Osaka (JP); Hitoshi ISHIMOTO, Hyogo (JP)

(21) Appl. No.: 18/139,228

(22) Filed: Apr. 25, 2023

Related U.S. Application Data
(63) Continuation of application No. PCT/JP21/26935, filed on Jul. 19, 2021.

(30) Foreign Application Priority Data
Oct. 28, 2020 (JP) 2020-180299

(51) Int. Cl. G01L 1/14

(52) U.S. Cl. CPC G01L 1/14

(57) ABSTRACT

A load sensor includes: a first base member and a second base member disposed so as to face each other; an electrically-conductive elastic body disposed on an opposing face of the first base member; a wire member that is electrically conductive and disposed between the second base member and the electrically-conductive elastic body; and a dielectric body disposed between the electrically-conductive elastic body and the wire member. A permittivity of the dielectric body is changed in a contact surface direction in which contact of the dielectric body advances in association with increase in a load, such that a form of change in capacitance between the electrically-conductive elastic body and the wire member associated with change in the load becomes close to that of a straight line.

### CROSS REFERENCE TO RELATED APPLICATION

This application is a continuation of International Application No. PCT/JP2021/026935 filed on Jul. 19, 2021, entitled “LOAD SENSOR”, which claims priority under 35 U.S.C. Section 119 of Japanese Patent Application No. 2020-180299 filed on Oct. 28, 2020, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. 2018/096901 describes a pressure-sensitive element that includes: a first electrically-conductive member formed from a sheet-shaped electrically-conductive rubber; a second electrically-conductive member sandwiched by the first electrically-conductive member and a base member; and a dielectric body formed so as to cover the second electrically-conductive member. In this configuration, in association with increase in a load, the contact area between the first electrically-conductive member and the dielectric body increases, and in association therewith, capacitance between the first electrically-conductive member and the second electrically-conductive member increases. Therefore, when the value of capacitance between the first electrically-conductive member and the second electrically-conductive member is detected, the load applied to the pressure-sensitive element can be detected.

However, in the above configuration, the second electrically-conductive member has a linear shape. Thus, the contact area does not linearly increase in accordance with increase in the load, and the relationship between the load and the capacitance is defined by a curved wave shape. Therefore, when the load is obtained from the value of the capacitance, this wave shape needs to be taken into consideration. This causes a problem that the process of detecting the load becomes complicated.

### SUMMARY OF THE INVENTION

An aspect of the present invention relates to a load sensor. The load sensor according to the present aspect includes: a first base member and a second base member disposed so as to face each other; an electrically-conductive elastic body disposed on an opposing face of the first base member; a wire member that is electrically conductive and disposed between the second base member and the electrically-conductive elastic body; and a dielectric body disposed between the electrically-conductive elastic body and the wire member. A permittivity of the dielectric body is changed in a contact surface direction in which contact of the dielectric body advances in association with increase in a load, such that a form of change in capacitance between the electrically-conductive elastic body and the wire member associated with change in the load becomes close to that of a straight line.

According to the load sensor of the present aspect, the form of change in the capacitance between the electrically-conductive elastic body and the wire member associated with change in the load is made close to that of a straight line. Therefore, when the value of the capacitance between the electrically-conductive elastic body and the wire member is measured and a simple process based on a proportionality is applied to the measured value of the capacitance, the load applied to the load sensor can be appropriately detected. Accordingly, the load applied to the load sensor can be detected in a simpler manner.

The effects and the significance of the present invention will be further clarified by the description of the embodiments below. However, the embodiments below are merely examples for implementing the present invention. The present invention is not limited to the embodiments below in any way.

### BRIEF DESCRIPTION OF THE DRAWINGS

FIG. 1A is a perspective view schematically showing a base member on the lower side and electrically-conductive elastic bodies set on an opposing face of the base member on the lower side, according to Embodiment 1;

FIG. 1B is a perspective view schematically showing a state where conductor wires are set on the base member, according to Embodiment 1;

FIG. 2A is a perspective view schematically showing a base member on the upper side and electrically-conductive elastic bodies set on an opposing face of the base member on the upper side, according to Embodiment 1;

FIG. 2B is a perspective view schematically showing a load sensor of which assembly has been completed, according to Embodiment 1;

FIG. 3A and FIG. 3B are each a cross-sectional view schematically showing surroundings of a conductor wire viewed in an X-axis negative direction, according to Embodiment 1;

FIG. 4 is a plan view schematically showing the inside of the load sensor viewed in a Z-axis negative direction, according to Embodiment 1;

FIG. 5A is a diagram schematically showing a relationship between a dielectric body and an electrically-conductive elastic body in an initial state before a load is applied, according to Embodiment 1;

FIG. 5B is a diagram schematically showing a relationship between the dielectric body and the electrically-conductive elastic body in a state where a load is applied, according to Embodiment 1;

FIG. 6 is a diagram describing a method for dividing the dielectric body in the circumferential direction in verification, according to the embodiment;

FIG. 7A is a table showing the material applied to each section and the presence or absence of contact at each contact angle in each section, in the verification of the embodiment;

FIG. 7B is a table showing calculated values, obtained through simulation, of an increment of the capacitance and the total capacitance when the contact angle is each angle in the uppermost row, in the verification of the embodiment;

FIG. 8A and FIG. 8B are each a graph showing a verification result with respect to the embodiment;

FIG. 9A is a table showing the material applied to each section and the presence or absence of contact at each contact angle in each section, in the verification of a comparative example;

FIG. 9B is a table showing calculated values, obtained through simulation, of an increment of the capacitance and the total capacitance when the contact angle is each angle in the uppermost row, in the verification of the comparative example;

FIG. 10A and FIG. 10B are each a graph showing a verification result with respect to the comparative example;

FIG. 11A is a diagram schematically showing a relationship between the dielectric body and the electrically-conductive elastic body in an initial state before a load is applied, according to Embodiment 2;

FIG. 11B is a diagram schematically showing a relationship between the dielectric body and the electrically-conductive elastic body in a state where a load is applied, according to Embodiment 2;

FIG. 12A is a diagram schematically showing a relationship between dielectric bodies and the wire member in an initial state before a load is applied, according to Embodiment 3; and

FIG. 12B is a diagram schematically showing a relationship between the dielectric bodies and the wire member in a state where a load is applied, according to Embodiment 3.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected.

Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensors in the embodiments below are each a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to a detection circuit, and the load sensor and the detection circuit form a load detection device. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

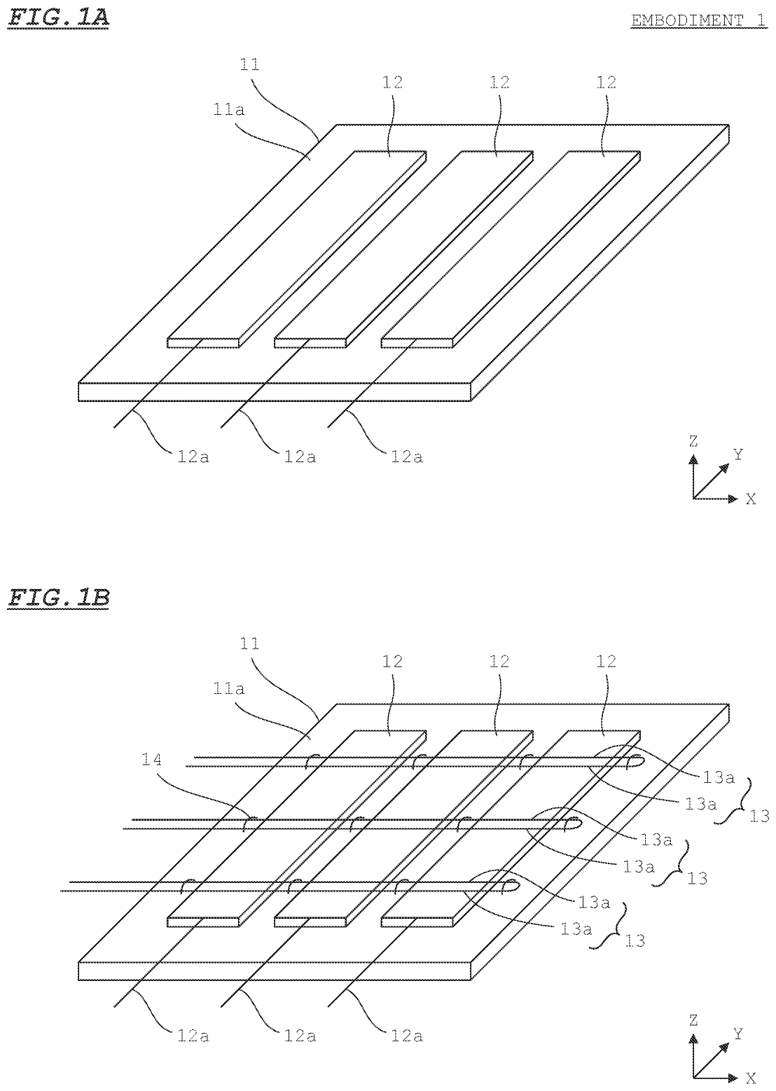

A configuration of the load sensor 1 will be described with reference to FIG. 1A to FIG. 4.

FIG. 1A is a perspective view schematically showing a base member 11, and three electrically-conductive elastic bodies 12 set on an opposing face 11a (the face on the Z-axis positive side) of the base member 11.

The base member 11 is an insulative member having elasticity, and has a flat plate shape parallel to an X-Y plane. The base member 11 is formed from a non-electrically-conductive resin material or a non-electrically-conductive rubber material. The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face 11a (the face on the Z-axis positive side) of the base member 11. In FIG. 1A, three electrically-conductive elastic bodies 12 are formed on the opposing face 11a of the base member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

Each electrically-conductive elastic body 12 is formed on the opposing face 11a of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the base member 11. However, the method for forming the electrically-conductive elastic body 12 is not limited to the printing methods.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (polydimethylpolysiloxane (e.g., PDMS)), an acrylic resin, a rotaxane-based resin, a urethane-based resin, and the like, for example. Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); electrically-conductive fibers such as a metal-coated organic matter fiber and a metal wire (fiber state); and the like, for example.

FIG. 1B is a perspective view schematically showing a state where three pairs of conductor wires 13 are set on the base member 11.

Each pair of conductor wires 13 is formed by bending one conductor wire extending in the X-axis direction, and includes two conductor wires 13a extending from the bent position toward the X-axis negative direction. Two conductor wires 13a forming a pair of conductor wires 13 are disposed so as to be arranged with a predetermined interval therebetween. The pair of conductor wires 13 are disposed so as to be superposed on the upper faces of the three electrically-conductive elastic bodies 12 shown in FIG. 1A. Here, three pairs of conductor wires 13 are disposed so as to be superposed on the upper faces of the three electrically-conductive elastic bodies 12.

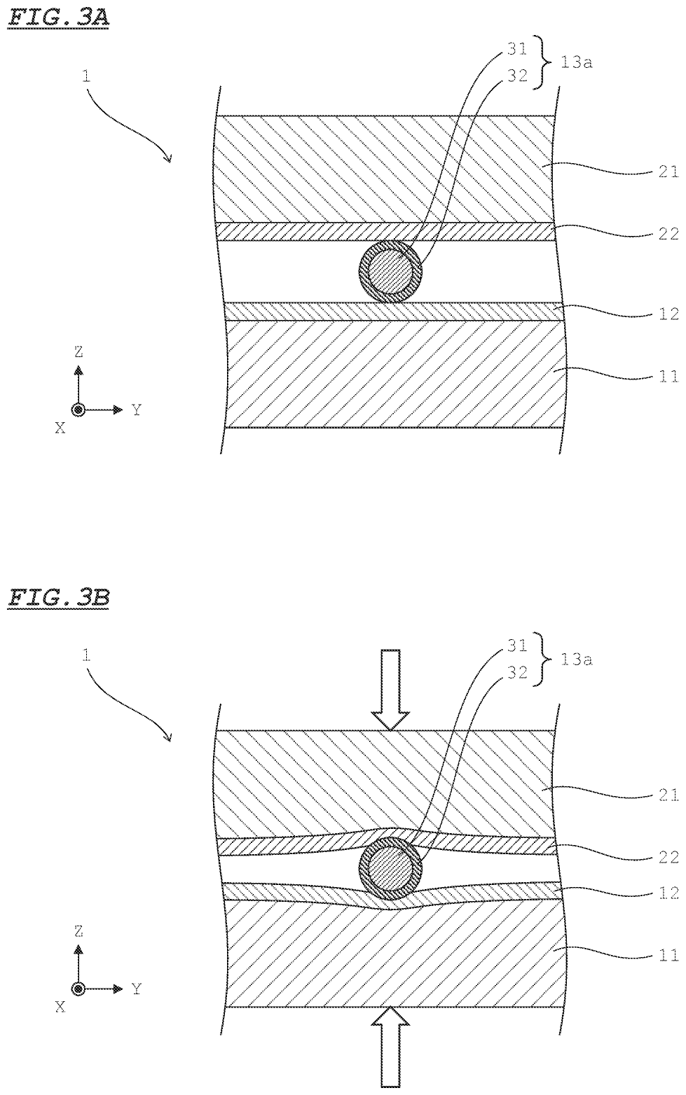

The three pairs of conductor wires 13 are disposed so as to cross the electrically-conductive elastic bodies 12, and are disposed so as to be arranged with a predetermined interval therebetween, along the longitudinal direction (the Y-axis direction) of the electrically-conductive elastic bodies 12. Each pair of conductor wires 13 is disposed, extending in the X-axis direction, so as to extend across the three electrically-conductive elastic bodies 12. Each conductor wire 13a includes an electrically-conductive member having a linear shape, and a dielectric body formed on the surface of the electrically-conductive member. The configuration of the conductor wire 13a will be described later with reference to FIGS. 3A, 3B.

After the three pairs of conductor wires 13 have been disposed as in FIG. 1B, each pair of conductor wires 13 is set on the base member 11 by threads 14 so as to be movable in the direction (the X-axis direction) in which the pair of conductor wires 13 extends. In the example shown in FIG. 1B, twelve threads 14 set the pairs of conductor wires 13 to the base member 11 at positions other than the positions where the electrically-conductive elastic bodies 12 and the pairs of conductor wires 13 overlap each other. Each thread 14 is implemented by a chemical fiber, a natural fiber, a mixed fiber of the chemical fiber and the natural fiber, or the like.

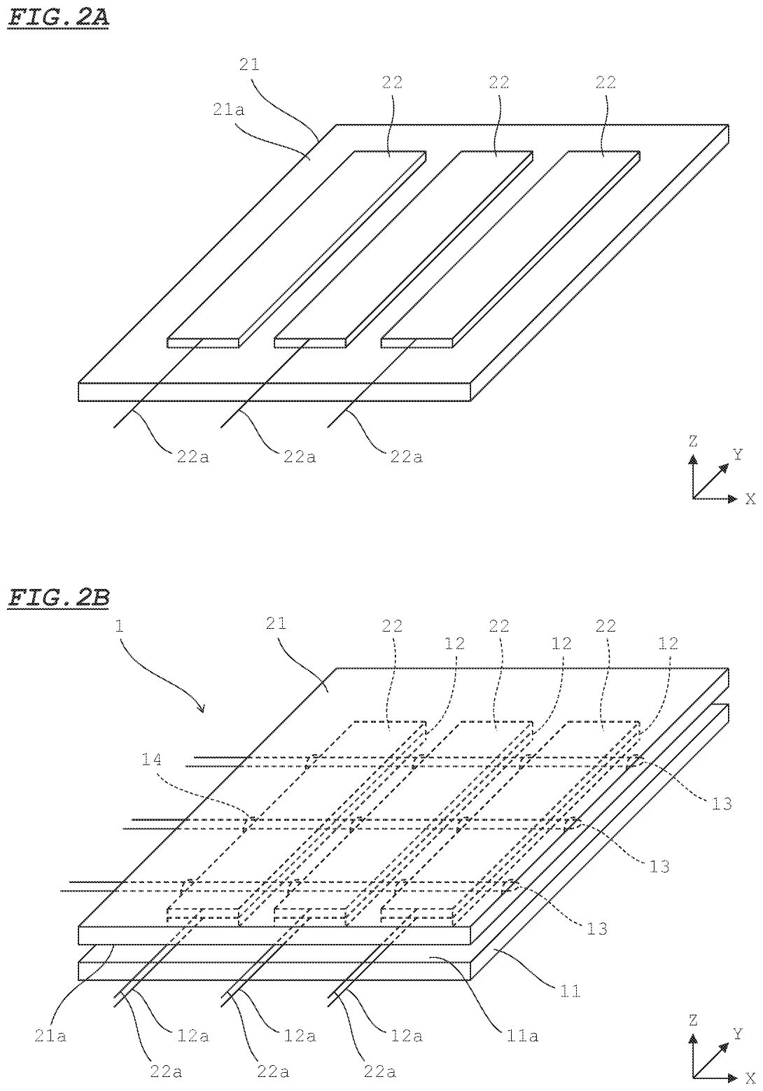

FIG. 2A is a perspective view schematically showing a base member 21 disposed so as to be superposed on the upper side of the base member 11, and three electrically-conductive elastic bodies 22 set on an opposing face 21a (the face on the Z-axis negative side) of the base member 21.

The base member 21 has the same size and shape as those of the base member 11, and is formed from the same material as that of the base member 11. The electrically-conductive elastic bodies 22 are formed, on the opposing face 21a (the face on the Z-axis negative side) of the base member 21, at positions opposing the electrically-conductive elastic bodies 12, and are formed so as to be arranged with a predetermined interval therebetween in the X-axis direction. Each electrically-conductive elastic body 22 has the same size and shape as those of the electrically-conductive elastic body 12, and is formed from the same material as that of the electrically-conductive elastic body 12. Similar to the electrically-conductive elastic body 12, the electrically-conductive elastic body 22 is formed on the face on the Z-axis negative side of the base member 21 by a predetermined printing method. The method for forming the electrically-conductive elastic body 22 is not limited to the printing methods, either. At an end portion on the Y-axis negative side of each electrically-conductive elastic body 22, a cable 22a electrically connected to the electrically-conductive elastic body 22 is set.

FIG. 2B is a perspective view schematically showing a state where the structure in FIG. 2A is set on the structure in FIG. 1B.

The structure shown in FIG. 2A is disposed from above (the Z-axis positive side) the structure shown in FIG. 1B. At this time, the base member 11 and the base member 21 are disposed such that: the opposing face 11a and the opposing face 21a face each other; and the electrically-conductive elastic bodies 12 and the electrically-conductive elastic bodies 22 are superposed with each other. Then, outer peripheral four sides of the base member 21 are connected to the outer peripheral four sides of the base member 11 with a silicone rubber-based adhesive, a thread, or the like, whereby the base member 11 and the base member 21 are fixed to each other. Accordingly, the three pairs of conductor wires 13 are sandwiched by the three electrically-conductive elastic bodies 12 and the three electrically-conductive elastic bodies 22. Thus, as shown in FIG. 2B, the load sensor 1 is completed.

FIGS. 3A, 3B are each a cross-sectional view schematically showing surroundings of a conductor wire 13a viewed in the X-axis negative direction. FIG. 3A shows a state where no load is applied, and FIG. 3B shows a state where loads are applied.

As shown in FIGS. 3A, 3B, the conductor wire 13a is composed of a wire member 31 and a dielectric body 32 formed on the wire member 31.

The wire member 31 is formed from an electrically-conductive metal material, for example. Other than this, the wire member 31 may be composed of a core wire made of glass, and an electrically-conductive layer formed on the surface of the core wire. Alternatively, the wire member 31 may be composed of a core wire made of resin, and an electrically-conductive layer formed on the surface of the core wire, for example. In Embodiment 1, the wire member 31 is formed from aluminum. The dielectric body 32 has an electric insulation property, and is formed from a resin material, a ceramic material, a metal oxide material, or the like, for example.

Other than the above, as the wire member 31, a valve action metal such as titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used. The diameter of the wire member 31 may be not less than 10 μm and not greater than 1500 μm, and may be not less than 50 μm and not greater than 800 μm, for example. Such a configuration of the wire member 31 is preferable from the viewpoint of the resistance and the strength of the wire member. The thickness of the dielectric body 32 is preferably not less than 5 nm and not greater than 100 μm, and can be selected as appropriate according to the design of the sensitivity of the sensor.

As shown in FIG. 3A, when no load is applied, the force applied between the electrically-conductive elastic body 12 and the conductor wire 13a, and the force applied between the electrically-conductive elastic body 22 and the conductor wire 13a are substantially zero. From this state, as shown in FIG. 3B, when a load is applied in the upward direction to the lower face of the base member 11 and a load is applied in the downward direction to the upper face of the base member 21, the electrically-conductive elastic bodies 12, 22 are deformed by the conductor wire 13a.

As shown in FIG. 3B, when loads are applied, the conductor wire 13a is brought close to the electrically-conductive elastic bodies 12, 22 so as to be wrapped by the electrically-conductive elastic bodies 12, 22, and the contact area between the conductor wire 13a and the electrically-conductive elastic body 12, 22 increases. Accordingly, the capacitance between the wire member 31 and the electrically-conductive elastic body 12 and the capacitance between the wire member 31 and the electrically-conductive elastic body 22 change. Then, the capacitance in the region of the conductor wire 13a is detected, whereby the load applied to this region is calculated.

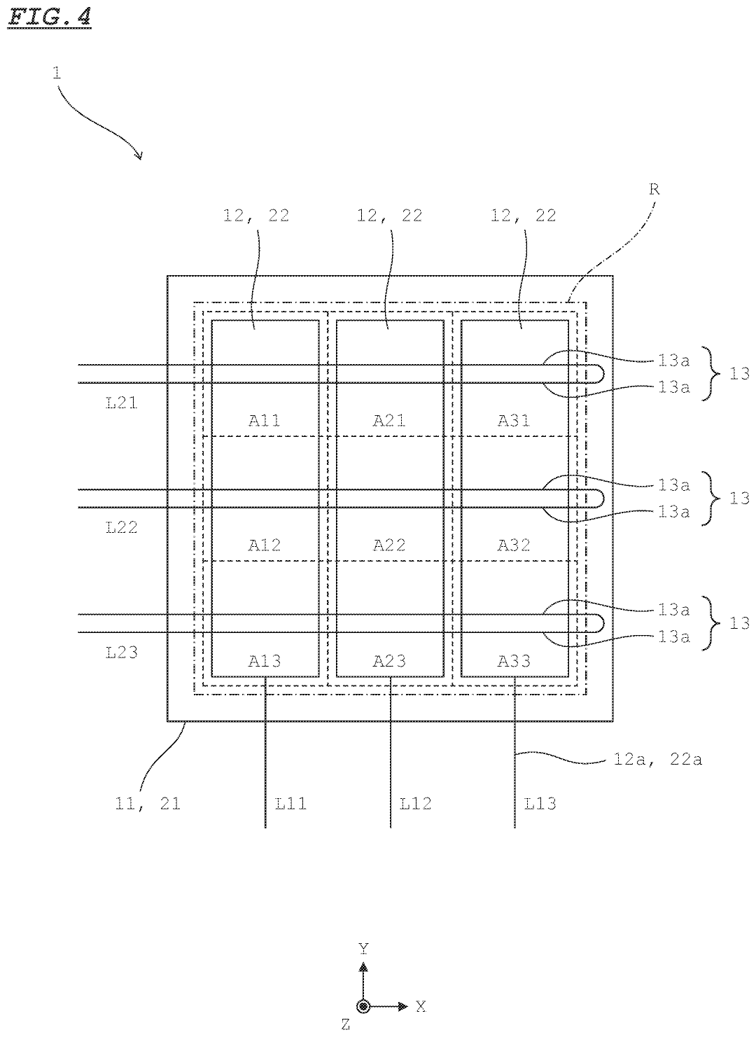

FIG. 4 is a plan view schematically showing the inside of the load sensor 1 viewed in the Z-axis negative direction. In FIG. 4, threads 14 are not shown, for convenience.

In a measurement region R of the load sensor 1, nine sensor parts arranged in the X-axis direction and the Y-axis direction are set. Specifically, nine regions obtained by dividing the measurement region R into three in the X-axis direction and dividing the measurement region R into three in the Y-axis direction are assigned as the nine sensor parts. The boundary of each sensor part is in contact with the boundary of a sensor part adjacent thereto. The nine sensor parts correspond to nine positions where the electrically-conductive elastic bodies 12, 22 and the pairs of conductor wires 13 cross each other. At these nine positions, nine sensor parts A11, A12, A13, A21, A22, A23, A31, A32, A33 in each of which capacitance changes in accordance with a load are formed.

Each sensor part includes electrically-conductive elastic bodies 12, 22 and a pair of conductor wires 13, and the pair of conductor wires 13 forms one pole (e.g., positive pole) for capacitance, and the electrically-conductive elastic bodies 12, 22 form the other pole (e.g., negative pole) for capacitance. That is, the wire member 31 (see FIGS. 3A, 3B) in the pair of conductor wires 13 forms one electrode of the load sensor 1 (capacitance-type load sensor), the electrically-conductive elastic bodies 12, 22 form the other electrode of the load sensor 1 (capacitance-type load sensor), and the dielectric body 32 (see FIGS. 3A, 3B) in the pair of conductor wires 13 corresponds to a dielectric body that defines capacitance in the load sensor 1 (capacitance-type load sensor).

When a load is applied in the Z-axis direction to each sensor part, the pair of conductor wires 13 (two conductor wires 13a) is wrapped by the electrically-conductive elastic body 12, 22 due to the load. Accordingly, the contact area between the pair of conductor wires 13 and the electrically-conductive elastic body 12, 22 changes, and the capacitance between the pair of conductor wires 13 and the electrically-conductive elastic body 12, 22 changes.

End portions on the X-axis negative side of each pair of conductor wires 13, an end portion on the Y-axis negative side of each cable 12a, and an end portion on the Y-axis negative side of each cable 22a are connected to a detection circuit provided for the load sensor 1.

In FIG. 4, the cables 12a, 22a drawn from the three sets of electrically-conductive elastic bodies 12, 22 are indicated as lines L11, L12, L13, and the wire members 31 in the three pairs of conductor wires 13 are indicated as lines L21, L22, L23. The positions at which the electrically-conductive elastic bodies 12, 22 connected to the line L11 cross the lines L21, L22, L23 are the sensor parts A11, A12, A13, respectively. The positions at which the electrically-conductive elastic bodies 12, 22 connected to the line L12 cross the lines L21, L22, L23 are the sensor parts A21, A22, A23, respectively. The positions at which the electrically-conductive elastic bodies 12, 22 connected to the line L13 cross the lines L21, L22, L23 are the sensor parts A31, A32, A33, respectively.

When a load is applied to the sensor part A11, the contact area between the pair of conductor wires 13 and the electrically-conductive elastic body 12, 22 increases in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

Meanwhile, in the configuration of the present embodiment, as shown in FIGS. 3A, 3B, the dielectric body 32 is formed so as to cover the periphery of the wire member 31, and thus, the contact area between the dielectric body 32 and the electrically-conductive elastic body 12, 22 does not linearly increase in accordance with increase in the load. As a result, the relationship between the load and the capacitance is defined by a curved wave shape. Therefore, when the load is obtained from the value of the capacitance, this wave shape needs to be taken into consideration. This causes a problem that the process of detecting the load becomes complicated.

Thus, in the present embodiment, a configuration for detecting, in a simpler manner, a load applied to the load sensor 1 is provided. Specifically, the permittivity of the dielectric body 32 is changed in a contact surface direction in which contact of the dielectric body 32 advances in association with increase in the load, such that the form of change in the capacitance between the electrically-conductive elastic body 12 and the wire member 31 associated with change in the load becomes close to that of a straight line.

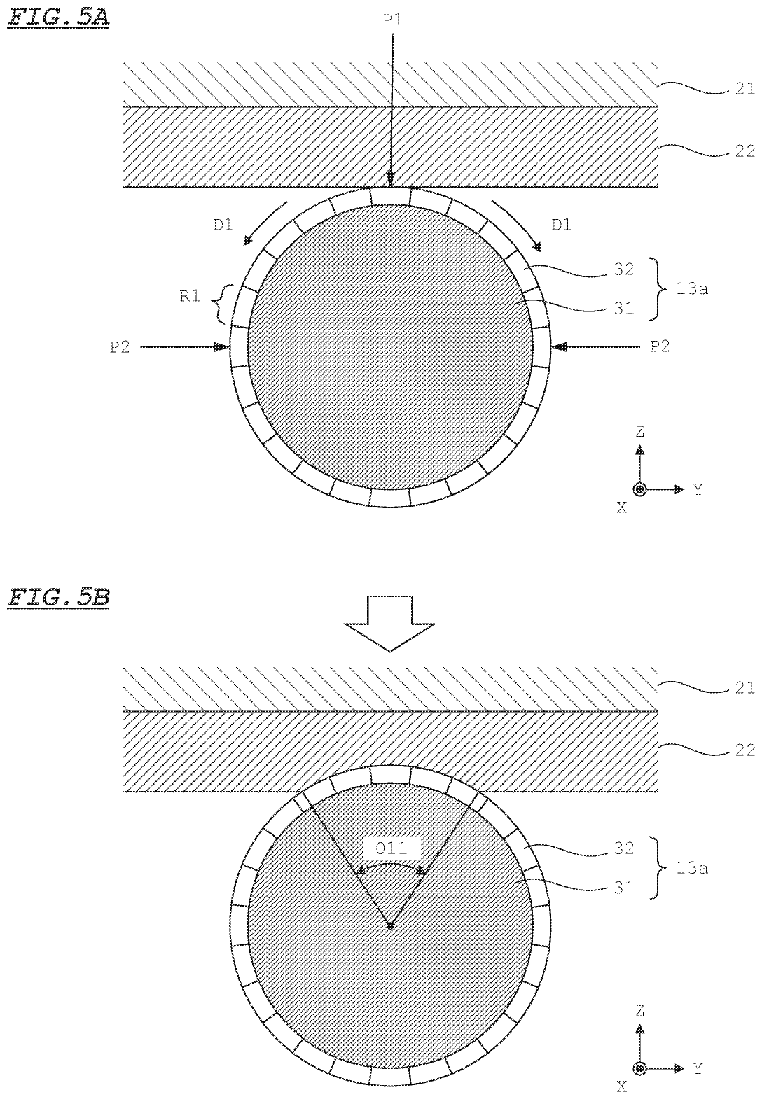

FIG. 5A is a diagram schematically showing a relationship between the dielectric body 32 and the electrically-conductive elastic body 22 in an initial state before a load is applied. FIG. 5B is a diagram schematically showing a relationship between the dielectric body 32 and the electrically-conductive elastic body 22 in a state where a load is applied. For convenience, FIGS. 5A, 5B show only the configuration on the electrically-conductive elastic body 22 side, and do not show the configuration on the electrically-conductive elastic body 12 side. However, on the electrically-conductive elastic body 12 side as well, a phenomenon similar to that on the electrically-conductive elastic body 22 side occurs in accordance with change in the load.

In FIG. 5A, D1 indicates the contact surface direction in which contact of the dielectric body 32 advances in association with increase in the load. As shown in FIG. 5A, the dielectric body 32 is divided into a plurality of regions R1 in the circumferential direction. The respective regions R1 of the dielectric body 32 are formed from materials having permittivities different from each other, and the materials forming the regions R1 can each be composed of a material having a permittivity of 9 or 3.4, or having a difference in permittivity of about three times. As representative examples, alumina (aluminum oxide) and polyimide (resin) are selected. The permittivity of alumina is significantly higher than the permittivity of polyimide. The materials forming the regions R1 are not limited to alumina and polyimide, and may be other materials. In FIG. 5A, the widths in the circumferential direction of the regions R1 are shown to be uniform, but the widths in the circumferential direction of the regions R1 may be nonuniform, that is, various widths may be present.

In the initial state of FIG. 5A, out of the regions R1 of the dielectric body 32, only the region R1 at the position (the position on the most Z-axis positive side) where the wire member 31 and the electrically-conductive elastic body 22 are closest to each other is in contact with the electrically-conductive elastic body 22. Then, when a load is applied to the load sensor 1, contact between the dielectric body 32 and the electrically-conductive elastic body 22 advances in the contact surface direction D1 while the electrically-conductive elastic body 22 is deformed, as shown in FIG. 5B. Accordingly, a plurality of regions R1 of the dielectric body 32 sequentially come into contact with the electrically-conductive elastic body 22. θ11 in FIG. 5B defines the contact range in the circumferential direction between the dielectric body 32 and the electrically-conductive elastic body 22, in terms of an angle (hereinafter, referred to as “contact angle”) in the circumferential direction. The contact angle θ11 increases in association with increase in the load.

Here, the permittivity in each region R1 is set to be, compared with that in a region R1 in the vicinity of a first position P1 sandwiched by the electrically-conductive elastic body 22 and the wire member 31 in the initial state before load application, higher in a region R1 in the vicinity of a second position P2 away in the contact surface direction D1 from the first position P1. The second position P2 is, for example, the upper limit position in a range where the dielectric body 32 can come into contact with the electrically-conductive elastic body 22 during load application (the position most away from the first position P1 in the range).

As shown in FIG. 5A, when the cross section of the wire member 31 is circular, in a range where the load is small, the contact area between the dielectric body 32 and the electrically-conductive elastic body 22 rapidly increases in association with increase in the load. In contrast, in a range where the load is large, the contact area gently increases in association with increase in the load. Therefore, when the permittivity of the dielectric body 32 is uniform over the entire circumference thereof, change in the capacitance associated with change in the load becomes sharp in a range where the load is small, and change in the capacitance associated with change in the load becomes gentle in a range where the load is large.

In contrast, as described above, when the permittivity is set to be, compared with that in a region R1 in the vicinity of the first position P1 sandwiched by the electrically-conductive elastic body 22 and the wire member 31 in the initial state before load application, higher in a region R1 in the vicinity of the second position P2 away in the contact surface direction D1 from the first position P1, change in the capacitance can be suppressed in the range where the load is small, because the permittivity of the dielectric body 32 is low, and change in the capacitance can be increased in the range where the load is large, because the permittivity of the dielectric body 32 is high. Accordingly, change in the capacitance due to change in the contact area, and change in the capacitance due to the permittivity can be complementarily balanced with each other. As a result, the relationship between the load and the capacitance can be made close to a linear relationship.

<Verification>

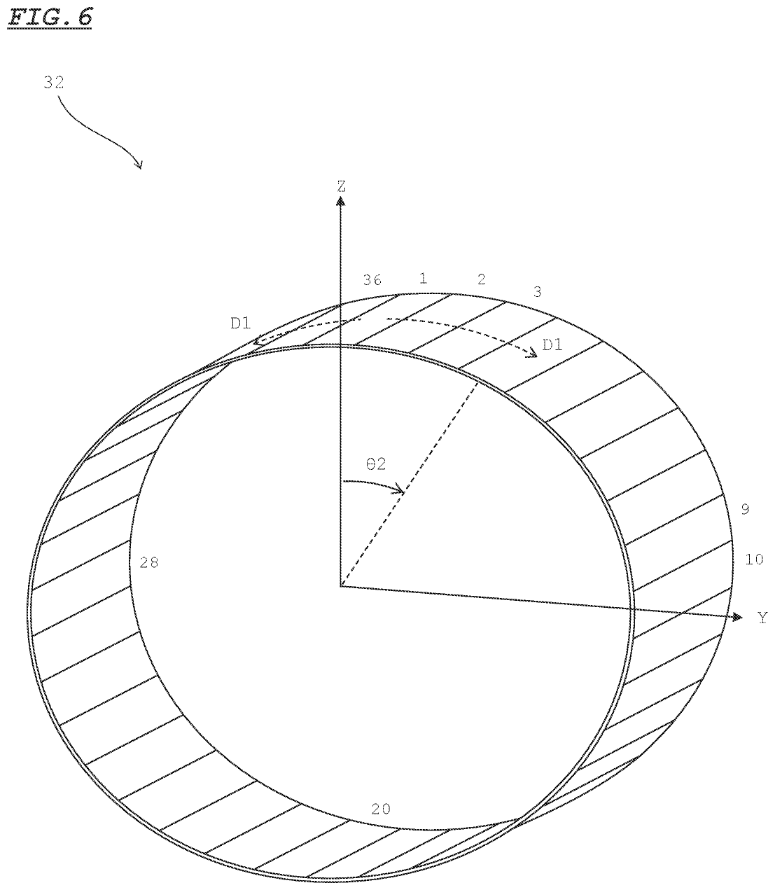

The inventors verified, through simulation, the relationship between the load and the capacitance when the permittivity in each region R1 was changed. In this verification, the dielectric body 32 was divided by 10° in a central angle θ2 direction into 36 sections as shown in FIG. 6, and in each section, a dielectric material of either one of alumina and polyimide was applied. In FIG. 6, the numbers assigned around the dielectric body 32 indicate the numbers of the respective sections. Here, the number of the section on the most Z-axis positive side is set to 1, and the number of each section increases in the direction of the central angle θ2. In the verification, the film thickness of the dielectric body 32 in each section where polyimide was applied was set to 6.5 μm, and the film thickness of the dielectric body 32 in each section where alumina was applied was set to 3 μm. The diameter of the wire member 31 was set to 0.326 mm.

The capacitance of the dielectric body 32 is in proportion to the permittivity, and is in inverse proportion to the film thickness. Therefore, when the film thickness of the dielectric body 32 in the section where alumina is applied is set to be smaller than the film thickness of the dielectric body 32 in the section where polyimide is applied, the difference in the capacitance between the two sections is further increased when compared with a case where only the materials are different.

Under this condition, while the materials, of the dielectric body, applied to the sections were caused to be different between the embodiment and a comparative example, the relationship between the load and the capacitance was verified through simulation. In the embodiment, alumina or polyimide was applied to each section such that, compared with the permittivity in the section of number 1 being in contact with the electrically-conductive elastic body 22 in the initial state, the permittivity in each section away in the contact surface direction D1 from the section of number 1 was increased. On the other hand, in the comparative example, in converse of the embodiment, alumina or polyimide was applied to each section such that, compared with the permittivity in the section of number 1, the permittivity in each section away in the contact surface direction D1 from the section of number 1 was decreased.

In this verification, the range where sections adjacent to each other and having the same material continue in the contact surface direction D1 corresponds to each region R1 shown in FIG. 5A. Meanwhile, a section having a material different from the materials of sections adjacent thereto in the contact surface direction D1 and the direction opposite thereto singly forms a region R1.

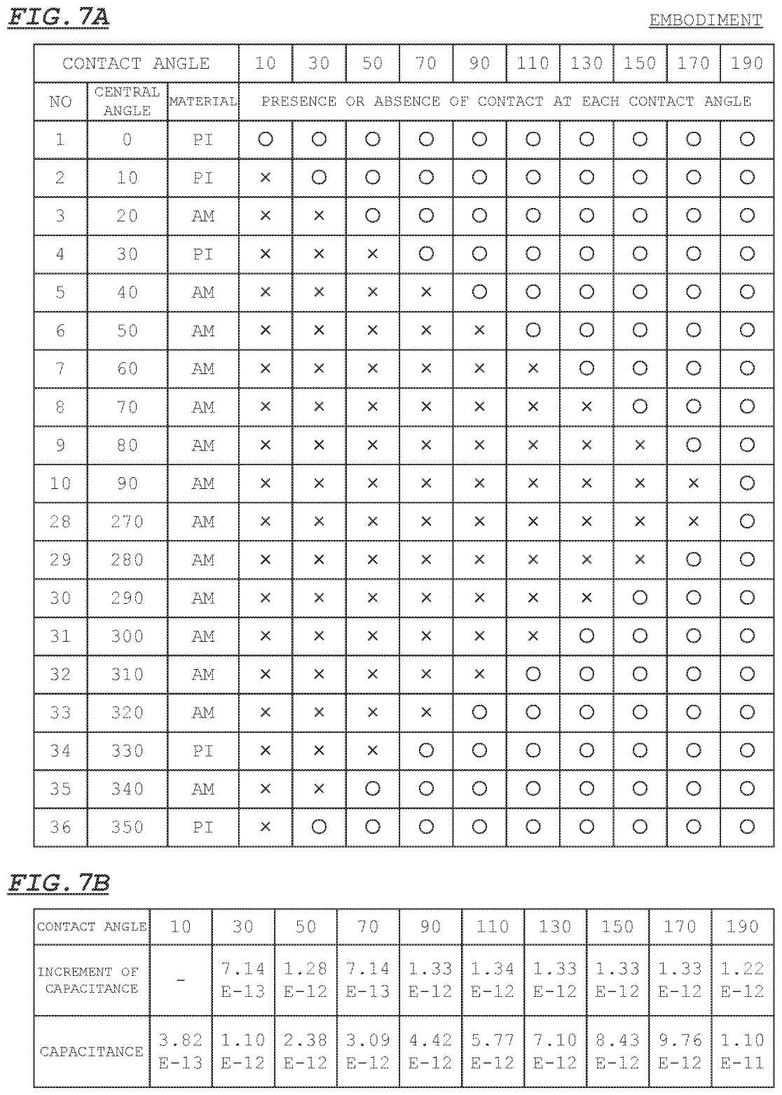

FIG. 7A is a table showing the material applied to each section and the presence or absence of contact at each contact angle in each section, in the verification of the embodiment.

In the table in FIG. 7A, “NO” indicates the number of each section shown in FIG. 6, and “central angle” indicates the central angle θ2, of each section, with respect to the center position in the circumferential direction. In “material”, PI indicates polyimide and AM indicates alumina. For example, in the verification of the embodiment, polyimide is applied to the section of number 1, which is in contact in the initial state, and alumina is applied to the sections of numbers 10, 28, which are in contact in a load application state.

In FIG. 7A, “∘” indicates that, when the dielectric body 32 and the electrically-conductive elastic body 22 are in contact with each other at each contact angle θ11 shown in the uppermost row, the corresponding section comes into contact with the electrically-conductive elastic body 22. “x” indicates that, when the dielectric body 32 and the electrically-conductive elastic body 22 are in contact with each other at each contact angle θ11 shown in the uppermost row, the corresponding section does not come into contact with the electrically-conductive elastic body 22. For example, when the contact angle θ11 shown in FIG. 5B is 10°, only the section of number 1 is in contact with the electrically-conductive elastic body 22, and when the contact angle θ11 is 30°, the sections of numbers 1, 2, 36 are in contact with the electrically-conductive elastic body 22.

FIG. 7B is a table showing calculated values, obtained through simulation, of an increment of the capacitance and the total capacitance when the contact angle θ11 is each angle in the uppermost row, in the verification of the embodiment.

For example, in the verification of the embodiment, when the contact angle θ11 is 10°, only the section of number 1 is in contact with the electrically-conductive elastic body 22 as shown in FIG. 7A. The capacitance between the dielectric body 32 and the electrically-conductive elastic body 22 in this case is 3.82×E⁻¹³. A load is applied from this state, and when the contact angle θ11 becomes 30°, the sections of numbers 2, 36 newly come into contact with the electrically-conductive elastic body 22. In this case, the increment of the capacitance due to the sections of numbers 2, 36 which have newly come into contact is 7.14×E⁻¹³, and the total capacitance between the dielectric body 32 and the electrically-conductive elastic body 22 is 1.10×E⁻¹².

In FIGS. 7A, 7B, out of the 36 sections, the relationship between the sections of the upper half (the Z-axis positive side) and the electrically-conductive elastic body 22 on the upper side is shown. However, the relationship between the sections on the lower half (the Z-axis negative side) and the electrically-conductive elastic body 12 on the lower side is also set in a similar manner. That is, as for the sections of the lower half, with reference to the section of number 20 opposite to the section of number 1, settings similar to those in FIGS. 7A, 7B are performed on the sections.

In the verification of the embodiment, change in the capacitance when the conductor wire 13 composed of two conductor wires 13a is sandwiched by the two electrically-conductive elastic bodies 12, 22 as shown in FIG. 2B, is calculated through simulation. This also applies to the comparative example described later.

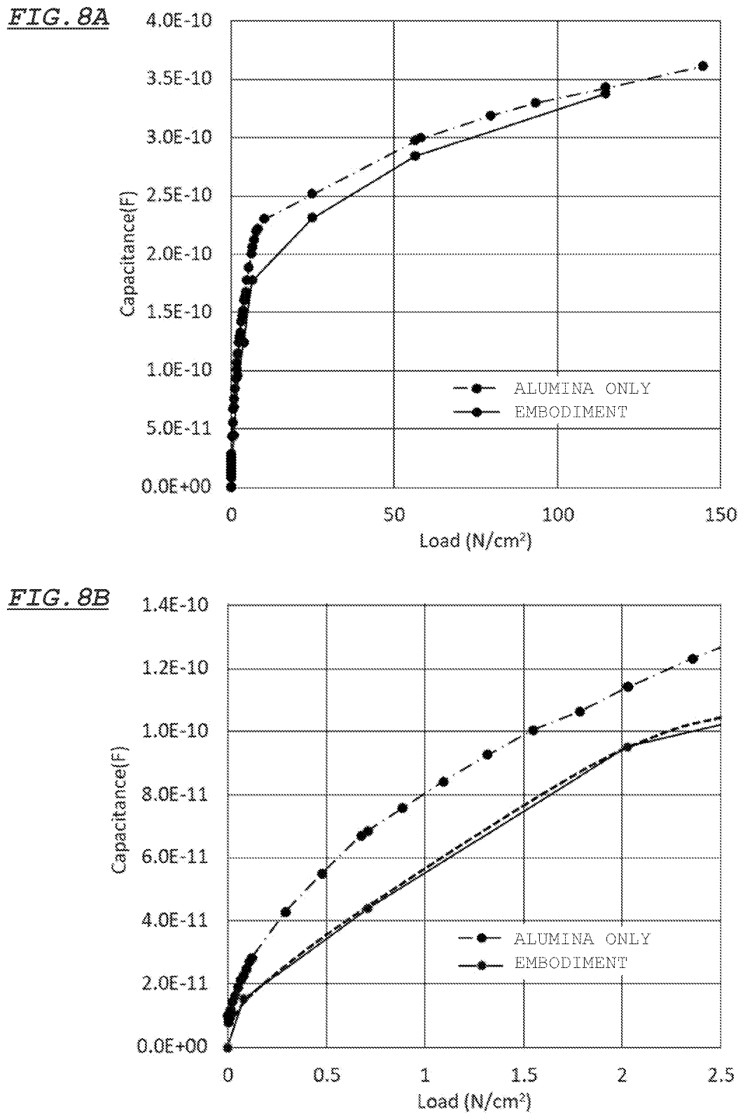

FIGS. 8A, 8B are each a graph showing the relationship between the load and the capacitance in the embodiment when the above verification condition is applied. FIG. 8B is an enlarged graph of the range where the load in FIG. 8A is 0 to 2.5 N/cm².

In FIGS. 8A, 8B, the horizontal axis represents the load and the vertical axis represents the capacitance. The verification result of the embodiment is indicated by a solid line. For comparison, a verification result when alumina was applied at a film thickness of 3 μm to all of the sections is indicated by a one dot chain line. Further, in FIG. 8B, a waveform obtained through curve approximation of the verification result of the embodiment is indicated by a broken line.

As shown in FIG. 8B, in the configuration of the embodiment, the waveform indicating the relationship between the load and the capacitance is substantially a straight line in a range of 0 to 2 N/cm² which is the detection range of the load sensor 1. Therefore, according to the configuration of the embodiment, when the value of the capacitance between the electrically-conductive elastic body 12, 22 and the conductor wire 13 is measured and a simple process based on a proportionality is applied to the measured value of the capacitance, the load applied to the load sensor 1 can be appropriately detected.

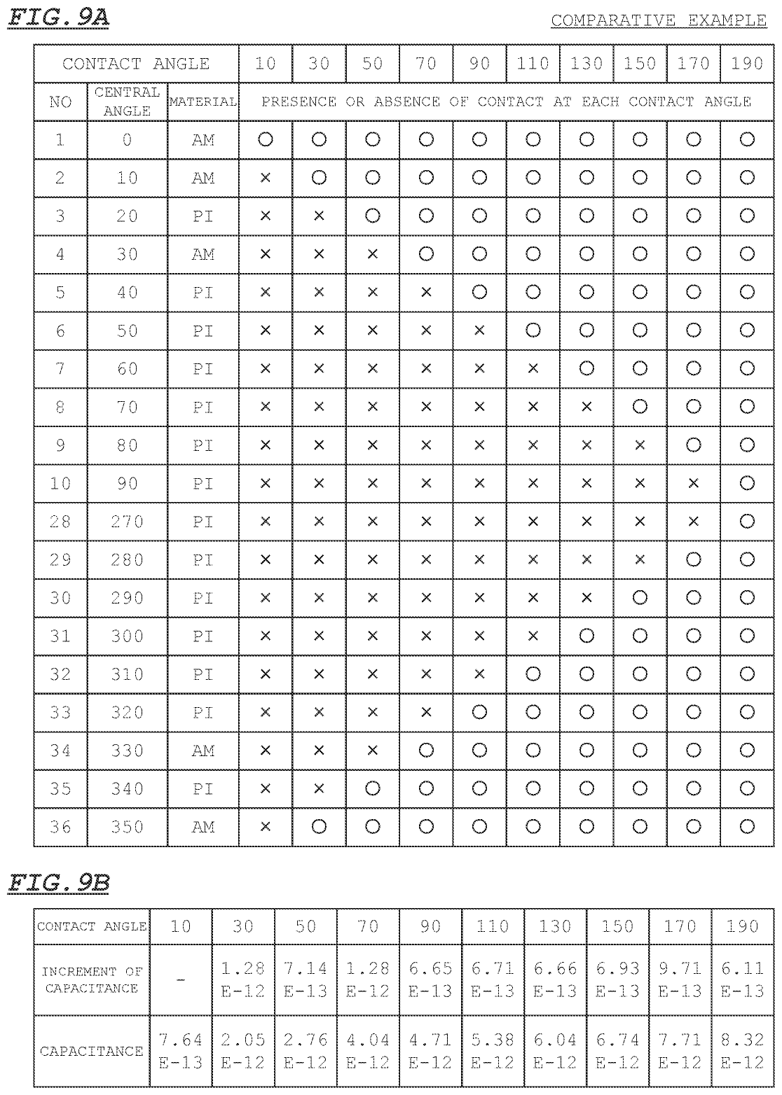

FIG. 9A is a table showing the material applied to each section and the presence or absence of contact at each contact angle in each section, in the verification of the comparative example. FIG. 9B is a table showing calculated values, obtained through simulation, of an increment of the capacitance and the total capacitance when the contact angle θ11 is each angle in the uppermost row, in the verification of the comparative example.

The configurations of FIGS. 9A, 9B are similar to those in FIGS. 7A, 7B. However, in FIG. 9A, the material applied to a section of each number is different from that in FIG. 7A. Specifically, in the comparative example, polyimide is applied to each section where alumina is applied in the embodiment in FIG. 7A, and alumina is applied to each section where polyimide is applied in the embodiment in FIG. 7A. Therefore, in the comparative example, compared with the permittivities in the sections of numbers 1, 20 which are in contact with the electrically-conductive elastic bodies 12, 22 in the initial state before load application, the permittivities in the sections away by not less than a predetermined distance in the contact surface direction D1 from those sections are smaller. The other conditions are the same as those in the embodiment above.

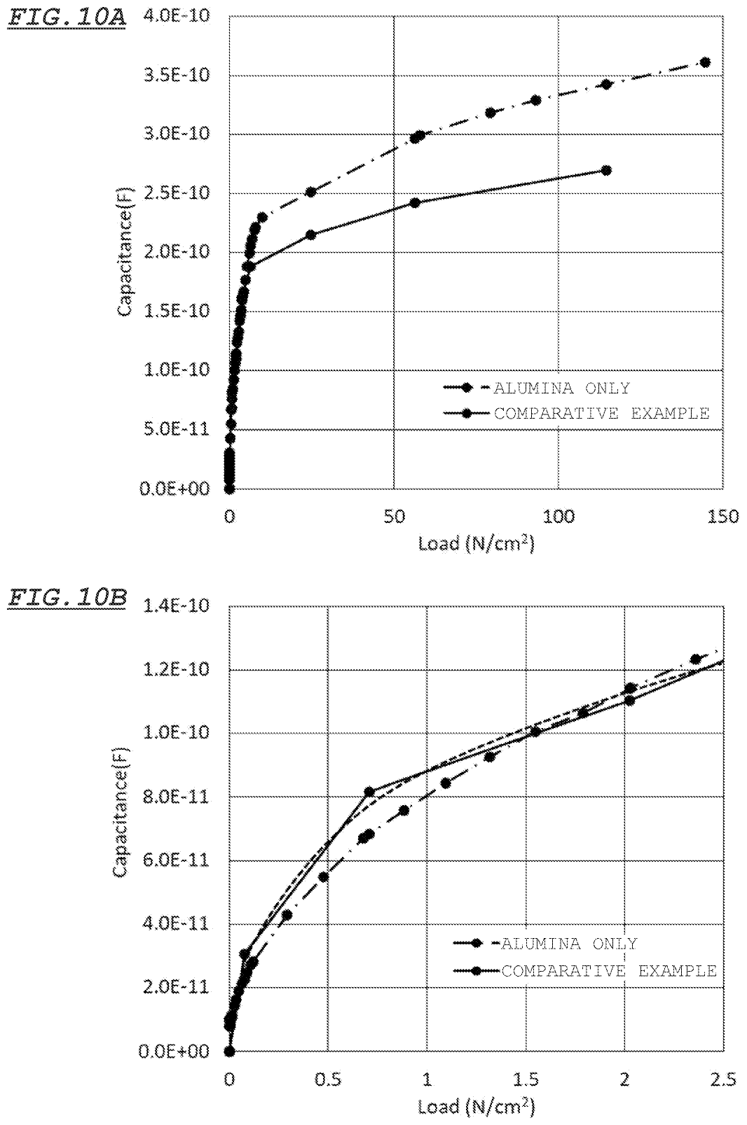

FIGS. 10A, 10B are each a graph showing the relationship between the load and the capacitance in the comparative example when the above verification condition is applied. FIG. 10B is an enlarged graph of the range where the load in FIG. 10A is 0 to 2.5 N/cm².

The vertical axis and the horizontal axis in FIGS. 10A, 10B are the same as those in FIGS. 8A, 8B. In FIGS. 10A, 10B as well, similar to FIGS. 8A, 8B, for comparison, a verification result when alumina was applied at a film thickness of 3 μm to all of the sections is indicated by a one dot chain line. The verification result of the comparative example is indicated by a solid line. Further, in FIG. 10B, a waveform obtained through curve approximation of the verification result of the comparative example is indicated by a broken line.

As shown in FIG. 10B, in the configuration of the comparative example, the waveform indicating the relationship between the load and the capacitance is bulged to a further extent than the waveform when all of the sections are formed from alumina. Thus, the verification result of the comparative example reveals the following. That is, when the permittivity of each section is set such that, compared with the permittivities in the sections of numbers 1, 20 which are in contact with the electrically-conductive elastic bodies 12, 22 in the initial state before load application, the permittivities in the sections away by not less than a predetermined distance in the contact surface direction D1 from those sections are smaller, the form representing the relationship between the load and the capacitance cannot be made close to that of a straight line. Therefore, in order to cause the form representing the relationship between the load and the capacitance to be close to that of a straight line, it is necessary to appropriately set the permittivity of each section.

### Effect of Embodiment 1

According to Embodiment 1, the following effects are exhibited.

As shown in the verification result in FIG. 8B, the form of change in the capacitance between the electrically-conductive elastic body 12, 22 and the wire member 31 associated with change in the load is made close to that of a straight line. Therefore, when the value of the capacitance between the electrically-conductive elastic body 12, 22 and the wire member 31 is measured and a simple process based on a proportionality is applied to the measured value of the capacitance, the load applied to the load sensor 1 can be appropriately detected. Accordingly, the load applied to the load sensor 1 can be detected in a simpler manner.

As shown in FIGS. 5A, 5B, in the configuration of Embodiment 1, the materials of the dielectric body 32 are caused to be different in the contact surface direction D1, whereby the permittivity of the dielectric body 32 is changed in the contact surface direction D1. According to this configuration, through a simple method in which the materials of the dielectric body 32 are caused to be different in the contact surface direction D1, the permittivity of the dielectric body 32 can be changed in the contact surface direction D1.

As shown in FIG. 5A, the permittivity of the dielectric body 32 is set to be, compared with that in the vicinity of the first position P1 sandwiched by the electrically-conductive elastic body 12, 22 and the wire member 31 in the initial state before load application, higher in the vicinity of the second position P2 away in the contact surface direction D1 from the first position P1. Accordingly, as described above, during load application, change in the capacitance due to change in the contact area, and change in the capacitance due to the permittivity can be balanced with each other. As a result, the relationship between the load and the capacitance can be made close to a linear relationship.

In the above verification, the dielectric body 32 has a thickness that is changed in the contact surface direction D1. Specifically, the film thickness of the dielectric body 32 in each region R1 where polyimide is applied is set to 6.5 μm, and the film thickness of the dielectric body 32 in each region R1 where alumina is applied is set to 3 μm. When the thickness of the dielectric body 32 decreases, the capacitance increases. Therefore, through adjustment of the thickness of the dielectric body 32 as well as the permittivity in the contact surface direction D1, the relationship between the load and the capacitance can be more easily made closer to a linear relationship.

As shown in FIGS. 3A, 3B, the dielectric body 32 is set so as to cover the surface of the wire member 31. According to this configuration, by merely covering the surface of the wire member 31 by the dielectric body 32, it is possible to set the dielectric body 32 between the electrically-conductive elastic bodies 12, 22 and the wire member 31.

As shown in FIGS. 3A, 3B, the electrically-conductive elastic body 12 is also disposed on the opposing face 11a of the base member 11, similar to the case of the opposing face 21a of the base member 21, and the permittivity of the dielectric body 32 is changed in the contact surface direction D1 in which contact of the dielectric body 32 advances in association with increase in the load, such that the form of change in the capacitance between the electrically-conductive elastic body 12, 22 and the wire member 31 associated with change in the load becomes close to that of a straight line. When the electrically-conductive elastic bodies 12, 22 are disposed on both the base members 11, 21, change in the capacitance due to change in the load can be made large when compared with a case where either one of the electrically-conductive elastic bodies 12, 22 is disposed, and the detection accuracy of the load can be increased. Further, since the permittivity of the dielectric body 32 is changed in the contact surface direction D1 in which contact of the dielectric body 32 advances in association with increase in the load, such that the form of change in the capacitance between the electrically-conductive elastic body 12, 22 and the wire member 31 associated with change in the load becomes close to that of a straight line, the load applied to the load sensor 1 can be detected accurately and in a simple manner.

As in the above verification, when alumina or polyimide is selectively applied to each region R1, the stress applied to the dielectric body 32 during load application can be relaxed by polyimide (resin) which is very elastic. Accordingly, while the characteristic of the capacitance with respect to a load is improved by using a metal oxide film having a high permittivity as the dielectric body, breakage of the dielectric body 32 due to the stress during load application can be prevented.

### Modification of Embodiment 1

In the verification condition shown in FIG. 7A, the number of types of materials selectively applied to the regions R1 of the dielectric body 32 is 2. However, the number of types of materials selectively applied to the regions R1 of the dielectric body 32 may be 3 or greater. When three or more types of materials having different permittivities are selectively applied to the regions R1, the form representing the relationship between the load and the capacitance during load application can be made more accurately close to that of a straight line, although the formation step of the dielectric body 32 becomes complicated.

In the above verification, as shown in FIG. 6, the dielectric body 32 is equally divided into 36 sections in the circumferential direction, whereby the regions R1 are formed. However, the method for setting the number and width of the regions R1 is not limited thereto. The number and width of the regions R1 in the contact surface direction D1 may be adjusted such that the form representing the relationship between the load and the capacitance during load application can be made more accurately close to that of a straight line. For example, in the vicinity of the first position P1 where the contact area rapidly changes due to change in the load, change in the permittivity may be finely controlled by setting the width of the regions R1 to be small. Meanwhile, in the vicinity of the second position P2 where the contact area gently changes due to change in the load, change in the permittivity may be gently controlled by setting the width of the regions R1 to be large.

In the above verification, the thickness of the dielectric body 32 is changed stepwise for each material, i.e., for each region R1. However, as long as the form representing the relationship between the load and the capacitance during load application can be made close to that of a straight line, the thickness of the dielectric body 32 in the contact surface direction D1 may be adjusted such that the thickness is linearly changed between adjacent regions R1.

In Embodiment 1 above, the dielectric body 32 is divided into a plurality of regions R1 in the contact surface direction D1, and the material of each region R1 is caused to be different, whereby the permittivity is changed stepwise between adjacent regions R1. However, the dielectric body 32 may be formed such that the permittivity is linearly changed in the contact surface direction D1.

### Embodiment 2

In Embodiment 1 above, the materials of the dielectric body 32 applied to the regions R1 are caused to be different, whereby the permittivity of the dielectric body 32 is changed in the contact surface direction D1. In contrast, in Embodiment 2, the number of laminated dielectric body layers forming the dielectric body 32 is changed in the contact surface direction D1, whereby the permittivity of the dielectric body 32 is changed in the contact surface direction D1.

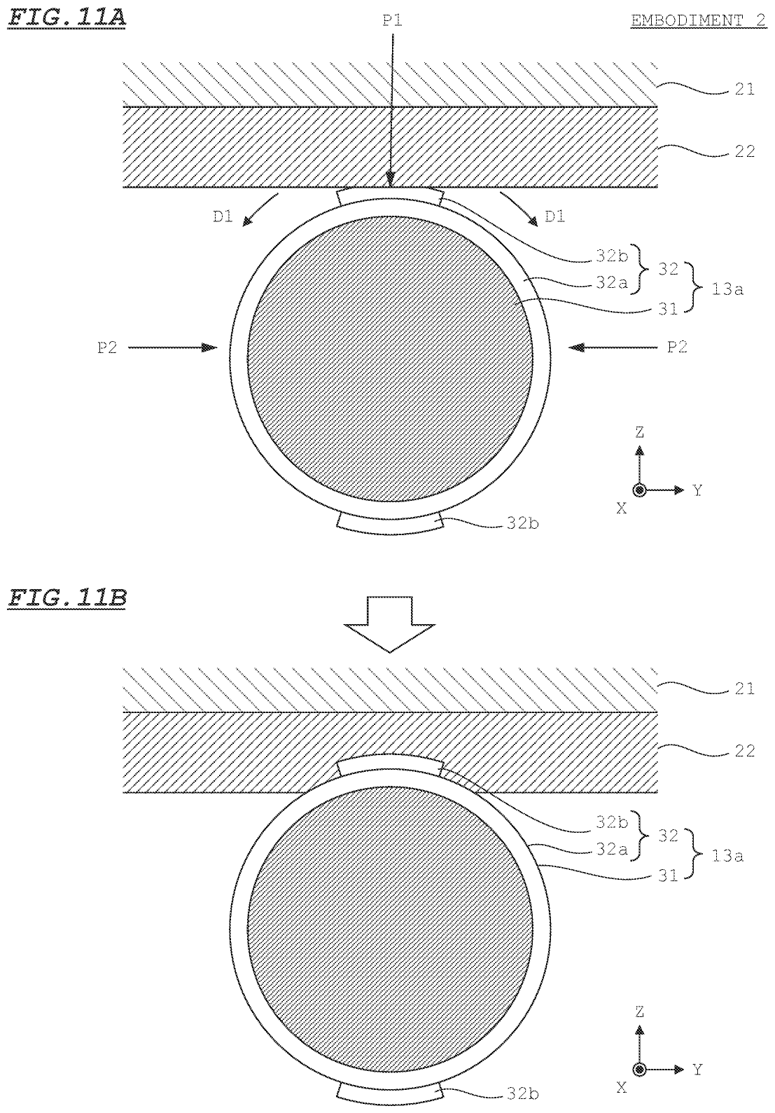

FIG. 11A is a diagram schematically showing a relationship between the dielectric body 32 and the electrically-conductive elastic body 22 in an initial state before a load is applied, according to Embodiment 2. FIG. 11B is a diagram schematically showing a relationship between the dielectric body 32 and the electrically-conductive elastic body 22 in a state where a load is applied, according to Embodiment 2. For convenience, FIGS. 11A, 11B show only the configuration on the electrically-conductive elastic body 22 side, and do not show the configuration on the electrically-conductive elastic body 12 side. However, on the electrically-conductive elastic body 12 side as well, a phenomenon similar to that on the electrically-conductive elastic body 22 side occurs in accordance with change in the load.

In the configuration in FIG. 11A, the dielectric body 32 is composed of a first dielectric body layer 32a and a second dielectric body layer 32b. The first dielectric body layer 32a is formed at a constant film thickness so as to cover the surface of the wire member 31 over the entire circumference thereof. The second dielectric body layer 32b is laminated at a constant film thickness so as to partially cover the surface of the first dielectric body layer 32a in the circumferential direction. The permittivity of the second dielectric body layer 32b is set to be lower than the permittivity of the first dielectric body layer 32a. Accordingly, the permittivity is decreased in the region where the second dielectric body layer 32b is formed when compared with that in the region where the second dielectric body layer 32b is not formed.

The first dielectric body layer 32a is formed from a metal oxide, for example, and the second dielectric body layer 32b is formed from a resin, for example. For example, the first dielectric body layer 32a is formed from alumina, and the second dielectric body layer 32b is formed from polyimide.

The region where the second dielectric body layer 32b is formed is adjusted such that the form of change in the capacitance between the electrically-conductive elastic body 22 and the wire member 31 associated with change in the load is close to that of a straight line. The region where the second dielectric body layer 32b is formed is adjusted such that, compared with the permittivity in the vicinity of the first position P1 sandwiched by the electrically-conductive elastic body 22 and the wire member 31 in the initial state before load application, the permittivity in the vicinity of the second position P2 away in the contact surface direction D1 from the first position P1 is higher.

Anodization (alumite treatment) is performed by applying an appropriate voltage (1 to 500 V) under a condition of 0° C. to 80° C. while using an organic acid solution or an inorganic acid solution of sulfuric acid, oxalic acid, phosphoric acid, boric acid, or the like. An arithmetic average roughness Ra at the surface of the dielectric body 32 may be not less than 0.01 μm and not greater than 100 μm, and may be not less than 0.05 μm and not greater than 50 μm, for example. In such a case, the dielectric body 32 can have a moderate interface adhesion to the electrically-conductive elastic bodies 12, 22. The arithmetic average roughness Ra may be obtained as follows: an average line of the locus of the boundary surface is obtained at a cross section, at three points, perpendicular to the longitudinal direction of the wire member 31; Ra based on each average line is measured in accordance with JIS B0601-1994; and the average value of the three measurement values is used as the arithmetic average roughness Ra.

When the dielectric body 32 (e.g., the first dielectric body layer 32a) is an oxide of aluminum, the dielectric body 32 may contain S, P, and N in an amount of 0.1 to 10 atm % other than aluminum as the main component. In such a case, the stress relaxation property of the dielectric body 32 itself is improved, and a crack or the like due to external pressure, impact, or the like can be inhibited. The dielectric body 32 that is amorphous is preferable because a similar effect can be obtained.

In the initial state in FIG. 11A, the second dielectric body layer 32b is in contact with the electrically-conductive elastic body 22, in the vicinity of the position (the position on the most Z-axis positive side: the first position P1) where the wire member 31 and the electrically-conductive elastic body 22 are closest to each other. Then, when a load is applied to the load sensor 1, contact between the dielectric body 32 and the electrically-conductive elastic body 22 advances in the contact surface direction D1 while the electrically-conductive elastic body 22 is deformed, as shown in FIG. 11B. Accordingly, in a range where the load is of not less than a predetermined magnitude, the first dielectric body layer 32a comes into contact with the electrically-conductive elastic body 22, and the permittivity of the dielectric body 32 is increased when compared with a case where the second dielectric body layer 32b is in contact with the electrically-conductive elastic body 22.

### Effect of Embodiment 2

As described above, according to Embodiment 2, the number of laminated dielectric body layers forming the dielectric body 32 is changed in the contact surface direction D1, whereby the permittivity of the dielectric body 32 can be changed in the contact surface direction D1. Therefore, through adjustment of the number of laminated dielectric body layers in the contact surface direction D1, the form of change in the capacitance between the electrically-conductive elastic body 12, 22 and the wire member 31 during load application can be made close to that of a straight line. Accordingly, similar to Embodiment 1 above, when the value of the capacitance between the electrically-conductive elastic body 12, 22 and the wire member 31 is measured and a simple process based on a proportionality is applied to the measured value of the capacitance, the load applied to the load sensor 1 can be appropriately detected, and the load applied to the load sensor 1 can be detected in a simpler manner.

Further, according to the configuration of Embodiment 2, through a simple method in which the number of laminated dielectric body layers is adjusted, the permittivity of the dielectric body 32 can be changed in the contact surface direction D1.

Further, according to the configuration in FIGS. 11A, 11B, the thickness of the dielectric body 32 is larger in the region where the second dielectric body layer 32b is formed than in the region where the second dielectric body layer 32b is not formed. Therefore, the capacitance in the region where the second dielectric body layer 32b is formed can be effectively decreased due to the thickness of the dielectric body 32 together with the difference in the permittivity of the second dielectric body layer 32b. Accordingly, the capacitance in the region where the second dielectric body layer 32b is formed can be adjusted in a simpler manner.

### Modification of Embodiment 2

In the configuration in FIGS. 11A, 11B, the thickness of the first dielectric body layer 32a is set to be constant, and the thickness of the second dielectric body layer 32b is set to be constant. However, these thicknesses need not necessarily be constant. In order to cause the form of change in the capacitance between the electrically-conductive elastic body 12, 22 and the wire member 31 during load application to be more accurately close to that of a straight line, these thicknesses may be changed in the contact surface direction D1.

In the configuration in FIGS. 11A, 11B, the thickness of the dielectric body 32 in the region where the second dielectric body layer 32b is formed is set to be larger than the thickness of the dielectric body 32 in the region where the second dielectric body layer 32b is not formed. However, as long as the form of change in the capacitance between the electrically-conductive elastic body 12, 22 and the wire member 31 during load application can be made close to that of a straight line, the thickness of the dielectric body 32 in the region where the second dielectric body layer 32b is formed and the thickness of the dielectric body 32 in the region where the second dielectric body layer 32b is not formed may be the same with each other. In this case, the thickness of the first dielectric body layer 32a in the region where the second dielectric body layer 32b is formed is set to be smaller than the thickness of the first dielectric body layer 32a in the other region.

In the configuration in FIGS. 11A, 11B, a single second dielectric body layer 32b is disposed in each of the upper half range and the lower half range of the first dielectric body layer 32a. However, as long as the form of change in the capacitance between the electrically-conductive elastic body 12, 22 and the wire member 31 during load application can be made close to that of a straight line, a plurality of the second dielectric body layers 32b may be disposed in each of the upper half range and the lower half range of the first dielectric body layer 32a.

In the configuration in FIGS. 11A, 11B, the maximum number of laminated dielectric body layers having different permittivities from each other is 2. However, the maximum number of laminated dielectric body layers having different permittivities from each other may be 3 or greater. In this case as well, the combination and the number of laminated dielectric body layers at each position in the contact surface direction D1 may be adjusted such that the form of change in the capacitance between the electrically-conductive elastic body 12, 22 and the wire member 31 during load application is more accurately close to that of a straight line.

In the configuration in FIGS. 11A, 11B, the first dielectric body layer 32a is formed from a single material. However, similar to Embodiment 1 above, the first dielectric body layer 32a may be divided into a plurality of regions in the contact surface direction D1, and the material applied to each section may be caused to be different. In this case as well, the material applied to each region of the first dielectric body layer 32a may be adjusted such that the form of change in the capacitance between the electrically-conductive elastic body 12, 22 and the wire member 31 during load application can be made more accurately close to that of a straight line. Similarly, the second dielectric body layer 32b may be divided into a plurality of regions in the contact surface direction D1, and the material applied to each section may be caused to be different.

In Embodiment 2 above, a dielectric body layer having a low permittivity is laminated on a dielectric body layer having a high permittivity. However, as long as the form of change in the capacitance between the electrically-conductive elastic body 12, 22 and the wire member 31 during load application can be made close to that of a straight line, a dielectric body layer having a high permittivity may be laminated on a dielectric body layer having a low permittivity.

### Embodiment 3

In Embodiments 1, 2 above, the dielectric body 32 is disposed on the surface of the wire member 31. However, a dielectric body may be formed on the surface of the electrically-conductive elastic body 12, 22.

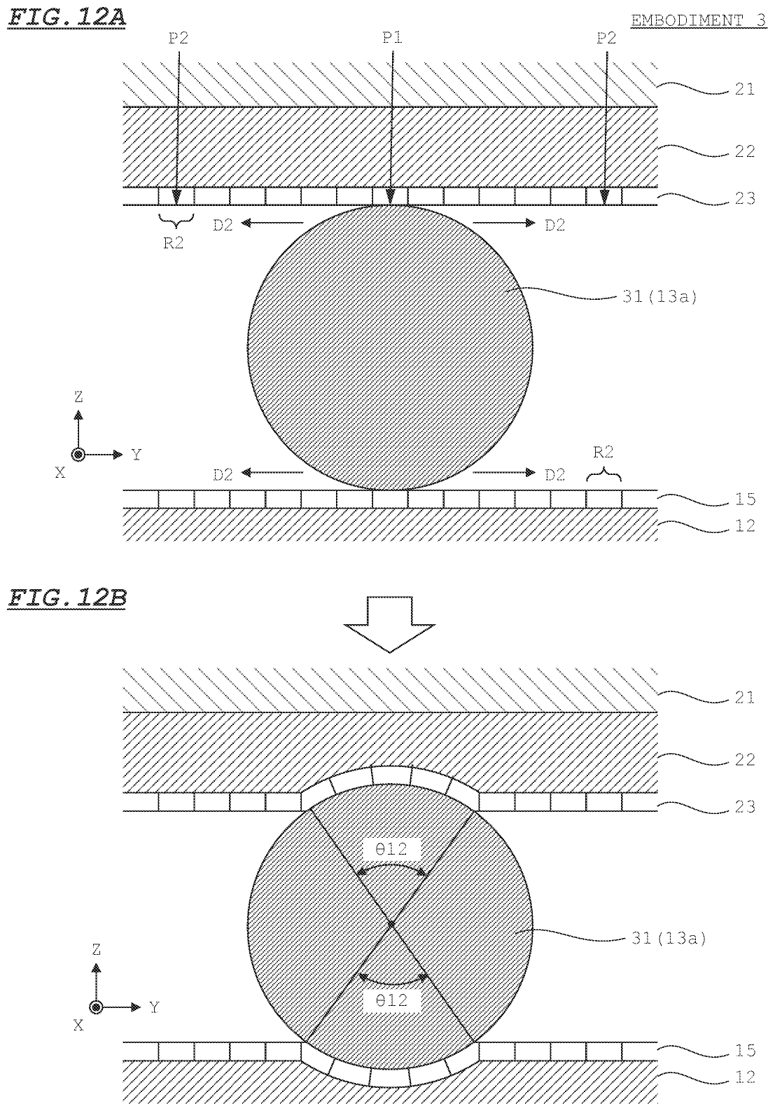

FIG. 12A is a diagram schematically showing a relationship between dielectric bodies 15, 23 and the wire member 31 in an initial state before a load is applied, according to Embodiment 3. FIG. 12B is a diagram schematically showing a relationship between the dielectric bodies 15, 23 and the wire member 31 in a state where a load is applied, according to Embodiment 3.

As shown in FIGS. 12A, 12B, in Embodiment 3, the dielectric bodies 15, 23 are respectively formed on the surfaces of the electrically-conductive elastic bodies 12, 22.

In FIG. 12A, D2 indicates a contact surface direction in which contact of the dielectric bodies 15, 23 advances in association with increase in the load. As shown in FIG. 12A, the dielectric bodies 15, 23 are each divided into a plurality of regions R2 in the circumferential direction. The respective regions R2 of the dielectric bodies 15, 23 are formed from materials having permittivities different from each other. The material forming each region R2 is selected from alumina (aluminum oxide) and polyimide (resin), for example. The permittivity of alumina is significantly higher than the permittivity of polyimide. The materials forming the regions R2 are not limited to alumina and polyimide, and may be other materials.

In FIG. 12A, the widths in the contact surface direction D2 of the regions R2 are shown to be uniform, but the widths in the contact surface direction D2 of the regions R2 may be nonuniform, that is, various widths may be present. In addition, similar to Embodiment 1 above, the thickness of each region R2 where a material (e.g., alumina) having a high permittivity is applied may be set to be smaller than the thickness of each region R2 where a material (e.g., polyimide) having a low permittivity is applied.

In the initial state in FIG. 12A, out of the regions R2 of the dielectric bodies 15, 23, only the regions R2 at the positions (the positions on the most Z-axis negative side and the most Z-axis positive side) where the wire member 31 and the electrically-conductive elastic bodies 12, 22 are closest to each other are in contact with the wire member 31. Then, when a load is applied to the load sensor 1, contact between the dielectric bodies 15, 23 and the wire member 31 advances in the contact surface direction D2 while the electrically-conductive elastic bodies 12, 22 are deformed, as shown in FIG. 12B. Accordingly, a plurality of regions R2 of the dielectric bodies 15, 23 sequentially come into contact with the wire member 31. θ12 in FIG. 12B is a contact angle. The contact angle θ12 increases in association with increase in the load.

Here, the permittivity in each region R2 is set to be, compared with that in a region R2 in the vicinity of the first position P1 sandwiched by the electrically-conductive elastic body 12, 22 and the wire member 31 in the initial state before load application, higher in a region R2 in the vicinity of the second position P2 away in the contact surface direction D2 from the first position P1. Similar to the above, the second position P2 is, for example, the upper limit position in a range where the dielectric bodies 15, 23 can come into contact with the wire member 31 during load application (the position most away from the first position P1 in the range). Accordingly, similar to Embodiment 1 above, during load application, change in the capacitance due to change in the contact area, and change in the capacitance due to the permittivity can be balanced with each other. As a result, the relationship between the load and the capacitance can be made close to a linear relationship.

### Effect of Embodiment 3

According to the configuration of Embodiment 3, by causing the materials applied to the regions R2 to be different, thereby adjusting the permittivities of the regions R2, it is possible to cause the form of change in the capacitance between the electrically-conductive elastic body 12, 22 and the wire member 31 during load application, to be close to that of a straight line. Accordingly, similar to Embodiment 1 above, when the value of the capacitance between the electrically-conductive elastic body 12, 22 and the wire member 31 is measured and a simple process based on a proportionality is applied to the measured value of the capacitance, the load applied to the load sensor 1 can be appropriately detected, and the load applied to the load sensor 1 can be detected in a simpler manner.

Further, similar to Embodiment 1 above, through adjustment of the thickness of the dielectric body 15, 23 in each region R2 as appropriate, the form of change in the capacitance between the electrically-conductive elastic body 12, 22 and the wire member 31 during load application can be more assuredly made close to that of a straight line.

### Modification of Embodiment 3

Similar to Embodiment 1 above, the number of types of materials selectively applied to the regions R2 of the dielectric bodies 15, 23 is not limited 2, and may be 3 or greater. The number and width of the regions R2 in the contact surface direction D2 may be adjusted such that the form representing the relationship between the load and the capacitance during load application can be made more accurately close to that of a straight line. In addition, as long as the form representing the relationship between the load and the capacitance during load application can be made close to that of a straight line, the thickness of the dielectric body 15, 23 in the contact surface direction D2 may be adjusted such that the thickness is linearly changed between adjacent regions R2. Further, the dielectric bodies 15, 23 may be formed such that the permittivity is linearly changed in the contact surface direction D2.

Similar to Embodiment 2 above, the dielectric body 15, 23 may be composed of a plurality of dielectric body layers that are laminated. In this case, the number of laminated dielectric body layers and the range of the lamination may be adjusted such that the form representing the relationship between the load and the capacitance during load application can be made close to that of a straight line.

### Other Modifications

In Embodiments 1 to 3 above, the cross-sectional shape of the wire member 31 is a circular shape. However, the cross-sectional shape of the wire member 31 is not limited to a circular shape, and may be another shape such as an ellipse, a pseudo circle, or the like. The wire member 31 may be implemented by a twisted wire obtained by twisting a plurality of wire members.

In Embodiments 1 to 3 above, as shown in FIG. 2B, the load sensor 1 includes three pairs of conductor wires 13. However, the load sensor 1 only needs to include at least one pair of conductor wires 13. For example, the number of pairs of conductor wires 13 included in the load sensor 1 may be 1.

In Embodiments 1 to 3 above, as shown in FIG. 2B, the load sensor 1 includes three sets of electrically-conductive elastic bodies 12, 22 that oppose each other in the up-down direction. However, the load sensor 1 only needs to include at least one set of electrically-conductive elastic bodies 12, 22. For example, the number of sets of electrically-conductive elastic bodies 12, 22 included in the load sensor 1 may be 1.

In Embodiments 1 to 3 above, the electrically-conductive elastic bodies 22 on the base member 21 side may be omitted. In this case, each pair of conductor wires 13 is sandwiched by the electrically-conductive elastic bodies 12 on the base member 11 side and the opposing face 21a of the base member 21, and the pair of conductor wires 13 sinks into the electrically-conductive elastic bodies 12 in accordance with the load, whereby capacitance in each sensor part changes. When the electrically-conductive elastic bodies 22 on the base member 21 side are omitted, a sheet-shaped base member may be set instead of the base member 21.

In Embodiments 1 to 3 above, one pair of conductor wires 13 has a shape in which two conductor wires 13a arranged in the Y-axis direction are connected to each other at end portions in the X-axis direction. However, instead of one pair of conductor wires 13, one conductor wire may be disposed, or three or more conductor wires may be disposed. Further, in a plan view, the shape of the pair of conductor wires 13 need not necessarily be a linear shape and may be a wave shape.

In addition to the above, various modifications can be made as appropriate to the embodiments of the present invention without departing from the scope of the technical idea defined by the claims.

What is claimed is:

1. A load sensor comprising:
a first base member and a second base member disposed so as to face each other;
an electrically-conductive elastic body disposed on an opposing face of the first base member;
a wire member that is electrically conductive and disposed between the second base member and the electrically-conductive elastic body; and
a dielectric body disposed between the electrically-conductive elastic body and the wire member, wherein
a permittivity of the dielectric body is changed in a contact surface direction in which contact of the dielectric body advances in association with increase in a load, such that a form of change in capacitance between the electrically-conductive elastic body and the wire member associated with change in the load becomes close to that of a straight line.

2. The load sensor according to claim 1, wherein
a material of the dielectric body is caused to be different in the contact surface direction, whereby the permittivity of the dielectric body is changed in the contact surface direction.

3. The load sensor according to claim 1, wherein
the number of laminated dielectric body layers forming the dielectric body is changed in the contact surface direction, whereby the permittivity of the dielectric body is changed in the contact surface direction.

4. The load sensor according to claim 1, wherein
the permittivity of the dielectric body is set to be, compared with that in a vicinity of a first position sandwiched by the electrically-conductive elastic body and the wire member in an initial state before load application, higher in a vicinity of a second position away in the contact surface direction from the first position.

5. The load sensor according to claim 1, wherein
the dielectric body has a thickness that is changed in the contact surface direction.

6. The load sensor according to claim 1, wherein
the dielectric body is set so as to cover a surface of the wire member.

7. The load sensor according to claim 1, wherein
another electrically-conductive elastic body is further disposed on an opposing face of the second base member,
the dielectric body is disposed also between the other electrically-conductive elastic body and the wire member, and
the permittivity of the dielectric body is changed in a contact surface direction in which contact of the dielectric body advances in association with increase in a load, such that a form of change in capacitance between the electrically-conductive elastic body and the wire member and between the other electrically-conductive elastic body and the wire member associated with change in the load becomes close to that of a straight line.
